(19) United States
(12) Patent Application Publication
(10) Pub. No.: US 2017/0178146 A1
(43) Pub. Date: Jun. 22, 2017

(54) HAZARDOUS MATERIAL HANDLING REFERENCE SYSTEM

(71) Applicant: Jon Mayer, Wayzata, MN (US)

(72) Inventor: Jon Mayer, Wayzata, MN (US)

(21) Appl. No.: 15/387,102

(22) Filed: Dec. 21, 2016

Related U.S. Application Data
(60) Provisional application No. 62/270,166, filed on Dec. 21, 2015.

(51) Int. Cl. G06Q 30/00; G06F 17/30; G06K 19/06

(52) U.S. Cl. CPC G06Q 30/018; G06K 19/06037; G06F 17/30755; G06K 19/06103

(57) ABSTRACT

A method and system of managing regulatory information associated with environment, health and safety data, such as MSDS data, including a database of regulatory data associated chemical products, and a database configured to maintain selected elements of the regulatory data, wherein the selected elements correspond to chemical products identified by the user, and a regulatory server configured to update the regulatory data with regulatory authorities received from a plurality of regulatory authorities. A server provides the user with compliance information relating to the selected elements in response to the user scanning a QR code on a label associated with a chemical container at a remote location with the user's cellular device, and provides the user with the option of receiving the compliance information via a text file or voice file, with said compliance information being communicated to the user at the remote location via the user's cellular device.

### RELATED APPLICATIONS

This application claims the benefit of U.S. Provisional Application No. 62/270,166, filed Dec. 21, 2015, and incorporated herein by reference.

### BACKGROUND

Many of today's work or emergency response environments involve hazardous materials, and the handling of these materials has been the subject of much study and evolving regulations. What was considered safe material handling even just a few years ago can be revised, even significantly, if new hazards pertaining to that material are discovered.

Governmental agencies at all levels have generated reference guidelines for the handling of hazardous materials. Examples of such guidelines include the Emergency Response Guidebook published by the US Department of Transportation. Other guidelines are contained in Material Safety Data Sheets (MSDS), soon to be renamed Safety Data Sheets, required by the US Occupational. Safety and Health Administration (OSHA) for various materials. These OSHA guidelines will be aligned with the Globally Harmonized System for Hazard Communication to make the guidelines more consistent around the world. The Department of Homeland Security also issues guidelines for handing various materials

Industries that may issue or use guidelines for the handling of materials include the railway safety enforcement system, industrial protection agencies, chemical and chemical engineering companies, finishing industries, and automotive chemical industries. Virtually every construction and transportation enterprise needs to know how to handle materials safely and in compliance with governmental and other regulations.

Given the complexity of these regulations, and the fact that they change with some frequency, staying up-to-date with the regulations, and having ready access to them during an emergency, while transporting materials, or at a worksite, can prove to be challenging. A need exists to provide easy access to the most up-to-date regulations in an efficient and effective way.

### SUMMARY

The invention includes a system providing communicative indicia, such as a printed label, to convey information to the user regarding the safe handling of a particular material. The label includes a barcode, matrix barcode, or two-dimensional barcode that can be scanned using a code-reading software application to access relevant material handling information on a user's personal electronic device. The relevant information will pertain to the material onto which the label is applied, and will desirably include the most up-to-date safe handling rules and regulations for that material.

The label or other indicia may also include color coding and symbols as currently required by many agencies. The indicia may be in any format including labels, packaging, shrink-wrapping, and the like. For purposes of this application, the word “indicia” shall be used interchangeably with the word “label.”

In one embodiment, the system provides real time technical information, for example, relative to the content of chemical substances regulated by regulations of a product put on a commercial distribution network.

In particular, the present invention refers to an innovative method and system, which allows, in real time, access to technical information that specifies the features of one or more of the products in question, particularly in the case of products of chemical nature, through the use of QR Code technology.

Access to the content stored within a remote database, and accessible via the QR Code technology, can be strictly controlled. Furthermore, the content can be fully-customized by the user (e.g, manufacturer, shipper, etc.). For example, a variety of audio and video files may be associated with a given QR Code. Real time language translation of the audio or video files may be provided.

Although various barcodes are described, the invention includes any type of readable indicia that can be scanned and translated by a user's personal electronic device to provide access to the relevant content pertaining to a particular material. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 illustrates a hazardous material placard.

FIG. 2 illustrates a first embodiment of a label used in conjunction with the system of the present invention.

FIG. 3 illustrates a second embodiment of a label for a single hazard placard.

### DETAILED DESCRIPTION

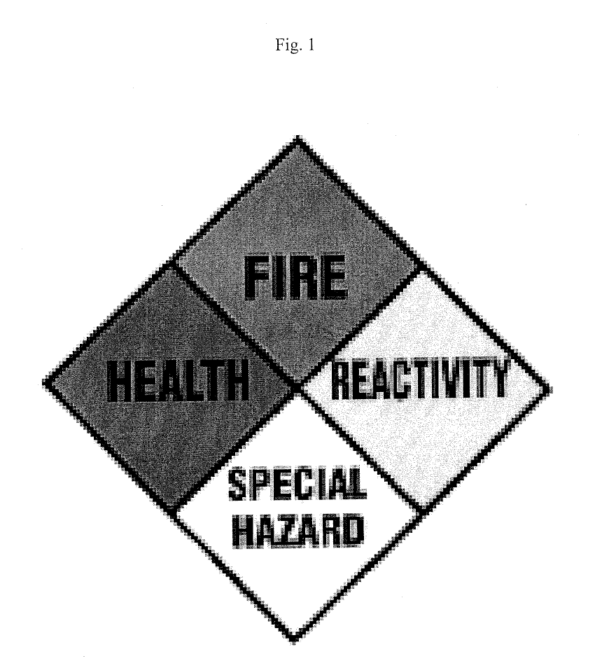

A label or other indicia of this invention includes a barcode, such as a matrix barcode, in conjunction with other material handling symbols. One example of a label with material handling symbols is shown in FIG. 1.

In embodiment of the present invention, the matrix barcode may link to resources such as the online Emergency Response Guidebook or similar regulations on the safe handling of materials.

In use, a user scans the barcode using their personal electronic device to obtain the proper guidelines for handing the material, without having to refer to a hardcopy version of the source of information, such as a guidebook or a printed MSDS.

The barcode may also link to a sound-generating website to obtain a voice file regarding the material. This may be useful when the worksite language is not English, so that the label's contents are understood by the local users without needing to obtain a translation separately. This aspect would be key in the world marketplace, for example as the Globally Harmonized System for Hazard Communication becomes widely adopted.

In one embodiment, the label works in conjunction with the other material handling symbols, words and colors (pictograms) to provide redundant communications regarding the material and its handling protocols, as is required by many regulatory agencies for safety purposes. For example, just by looking at the color of the label, a worker or emergency responder can immediately visually identify that special disposal of the material will be required for compliance with environmental regulations. Then, by scanning the barcode, the worker or responder will see what the specific disposal requirements are for that particular material.

In another example, a worker or emergency responder may see the flammable symbol on the label, and then can scan the barcode to determine what the flash point of the material is, or whether additional precautions, such as not exposing the material to water, are required.

As can be appreciated, each chemical has its own set of safe handling requirements, and the communicative indicia of the invention works to streamline the communication of those requirements.

Currently, the use of labels, such as the Hazard Communication placard shown in FIG. 1, requires that a worker or emergency responder look up a particular code out of over 150 codes in the particular guidebook to determine how to safely handle the material in question. Whether the guidebook is the most current, whether a subsequent revision particular to that material has been published, and whether the guidebook itself is physically accessible all may lead to time being spent in an emergency situation looking up how to handle a material in a hardcopy format instead of being able to rapidly respond to the situation.

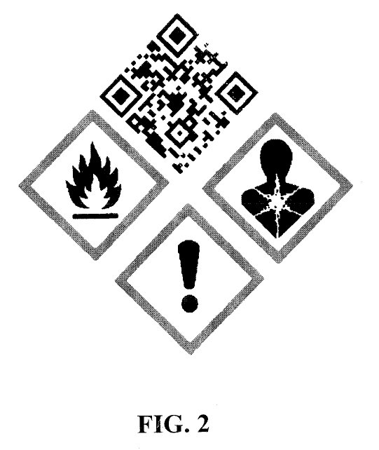

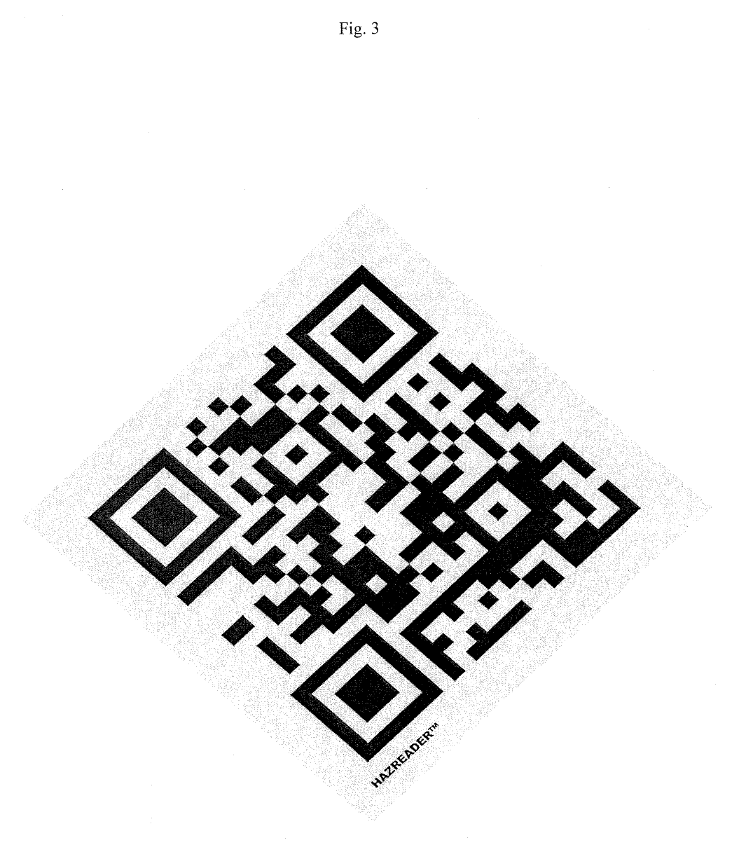

The system in accordance with the present invention overcomes this issue by providing a time-efficient and more informative method for obtaining material handling information, one example of which is shown in FIG. 2. Another example of a single hazard placard is shown in FIG. 3.

By scanning the barcode with a personal electronic device, or using an emergency response device specifically for reading barcodes, the user can quickly access the most up-to-date information about a material and how to handle it safely. Agencies charged with issuing regulations pertaining to hazardous materials will be able to update information on their website as regulations change, so that users have access to the most recent version of the regulation through the barcode access system.

This invention may be particularly useful as regulatory agencies adopt the Globally Harmonized System (GHS) of Classification and Labeling of Chemicals issued by the United Nations. Under this system, materials handling protocols are harmonized, and labeling requirements are standardized globally. Using this invention will permit the implementation of GHS protocols quickly and efficiently. A user will immediately know what the basic type of hazard is, and then by scanning the code on the label, will get more detailed information about handing the hazard to ensure that the proper response and actions are taken.

The label may be made of any suitable material for applying to a surface. The label may be printed with the color and code are printed at the same time onto the label material. Alternatively, the label may be made of a clear material, and the code printed onto the clear material, so that the label may be laid over an existing hazardous material placard so that the placard colors are visible under the code. The material may be a polymer film, reinforced paper, or any other material that can withstand the wear and tear associated with the particular use.

The present invention thus consists of an innovative system for supplying in real-time technical information relating to packages or articles, such as chemical substances regulated by rules of a relevant jurisdiction, and on the safety of use of the materials, as well as technical information on, for example, the specifications of the containers used for the transport of such materials or products.

As outlined above, an innovative system of information is based on the QR Code (Quick Read Code), a hi-dimensional bar code composed of black modules arranged inside a square scheme. Again, FIG. 2 schematizes a QR Code-based label which is applied on a product. The QR code, also called bi-dimensional bar code or QR code, is already well known in the state of the art. To extract or read the information contained in the QR CODE, a mobile phone (e.g., iPhone) or other device is provided with known software.

As used herein, the nomenclature “QR codes” means information handling technology for automatic identification and data capture according to ISO/IEC 18004, using QR Code 2005 symbology (2D graphic symbols). These standards cover symbology, data character encoding methods, symbol formats, dimensional characteristics, error-correction rules, reference decoding algorithms, production quality requirements and user-selectable application parameters. At present there are approximately 40 variants of 2D codes, each with certain advantages for a few specific-use parameters. The Open Mobile Alliance provides update white papers on future research areas for functional improvements of the general QR technology. A topic under active development is the QRME code which captures information of when and where the image was scanned. Such graphics are particularly valuable for critical sites and these technologies are being added as a feature of the present security systems.

Typical current QR codes contain about 2900 bytes of information (roughly 4300 ASCII characters, including error-compensation for dirt/scratches). The symbols are open standard and web linked; they are also inexpensive and no special equipment is needed to access them. At present, the most common use method for the technic is placement of a postage-stamp-sized graphic in print media; the symbol can then be imaged and interpreted by smartphone internal cameras. The phone automatically connects the user to a predetermined website and displays selected information, typically consumer product features or specifications.

The present invention provides selected unique QR elements to facilitate site visit activities; these include instantly-recognizable activity-related symbols or icons superimposed on the basic information matrix. In the case of emergency responders, traditional icons for each type of hazards are visible in the QR code matrix arrays displayed, e.g., fire, toxics, biohazards, explosion, pollution, ionizing-radiation and terrorism. The nomenclature “logical QR emblem”, as used in the following, means addition of a functional, logical or topical icon into any variant 2D code such as, but not limited to, QR, DataMatrix, MaxiCode or PDF417.

Site visitors with a cell phone may easily connect with significant data including: Agency or company contact information; Telephone or web access to website or social network; Access a data feed such as RSS, SMS or other; Access an email address or appointment calendar application; Access selected location data including GPS and address.

One unique aspect of the present invention is to use upscaled 2D symbols to provide an immediate link to a unique, secure activity-specific website. For example, an emergency-responder volunteer fireman needs immediate access to the complete, updated hazardous-materials inventory for the site along with the emergency-plan list of critical action items derived from material safety data (MSDS sheets) and other relevant technical data. The reader-devices provided to such crews would include a bright display (easily readable even in full sunlight) and adult-sized input keys to facilitate ongoing SQL-type web interactions by the crew leader with more than one remote database to validate his identity and to obtain particular, situation-related sensitive data without delays.

The particular QR Code, placed on a package containing any product, for example, allows the display of the information concerning the hazardous substances or regulated by rules in force in a given jurisdiction. The information can therefore be displayed on any smartphone provided with a QR Code reader or on another phone or tablet through an appropriate reading application software (many readers are downloadable for free from the Internet).

The decoded QR Code is therefore translated in an Internet address of a web page where the information requested are lodged and correspond to the specific QR Code read.

In particular, a first acquisition phase is foreseen of the information concerning the hazardous substances, or regulated by rules in force in the jurisdiction, contained in the product's in question (substance, mixture, solution, object, article, refuse, etc.) under the form of standardized documents. Such information is loaded on a web server (called, for simplicity purposes in the present description, central server) that contains a database of the information on the materials.

Importantly, the file can be managed by software (web platform) for the insertion/amendment of the customized information or for the exclusive access thereof. Basically, the web server is accessible through an ordinary Internet connection and contains an archive containing (obviously in downloadable electronic format) all the relevant files.

In an exemplary system use, a QR Code is therefore generated, which is linked univocally to a web page, which is lodged in the database placed on the web server, and that characterizes the type of product and the entity that placed it within the market or that transports it.

Next, the smart phone or other device acquires the image of the QR code and the code is decoded. The decoding actually creates an Internet connection, through the Internet, directly to the web server and therefore to the specific product present in the archive and to which the QR Code has been associated. In this way, there is direct access to the web server and therefore to the information arranged in the database.

The mobile device can display and download directly the files(s) of interest, thus allowing real-time access to relevant information.

Each QR code is associated to the electronic address that refers to the specific product in the archive. In this way, each user, in a quick and simple way, has immediately access to all the information of his interest directly in his mobile device.

In this manner, as soon as a technical information is required, for example for the purpose of storing or transporting these dangerous substances (especially chemical substances in the form of gas, liquid or solid), the information can be retrieved immediately by reading the QR Code associated with the label.

The approval for access depends solely on the decision of the publisher of the QR Code containing label. Advantageously, the system may require a specific user ID and password for the reading of the files related to the QR code. In other cases, for example for materials destined to the private sector, a “public” QR Code for free reading without protection can be foreseen for not dangerous substances.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of managing environmental health and safety information and compliance with regulatory provisions governing chemicals, comprising:
accumulating information associated with a plurality of chemicals in a database, the accumulated information including regulatory data corresponding to each of the chemicals;
maintaining regulatory filters for a customer, wherein the regulatory filters are configured based on relevance of the regulatory data to the customer;
filtering the regulatory accumulated information using the regulatory filters to obtain compliance information relevant to the customer;
providing the customer with the compliance information in response to the customer scanning a QR code on a label associated with a chemical container at a remote location with the customer's cellular device; and
providing the customer with the option of receiving the compliance information via a text file or voice file, with said compliance information being communicated to the customer at the remote location via the customer's cellular device.

2. The method of claim 1 wherein the regulatory data includes material safety data sheet (MSDS) data.

3. The method of claim 1 further comprising:
providing the customer with the option of receiving the compliance information via a voice file in a language different than a local language.

4. The method of claim 3 wherein the voice file is language-translated MSDS data.

5. A method of managing regulatory information associated with environmental, health and safety data, comprising:
maintaining a database of regulatory data associated with a plurality of chemicals;
mapping selected elements of the regulatory data to corresponding elements in a user system, wherein the selected elements are associated with chemical products identified by the user system;
updating the regulatory data with regulatory updates received from a plurality of regulatory authorities;
synchronizing the corresponding elements with the selected element;
filtering the regulatory data to obtain compliance information relevant to the user;
providing the user with the compliance information in response to the user scanning a QR code on a label associated with a chemical container at a remote location with the user's cellular device; and
providing the user with the option of receiving the compliance information via a text file or voice file, with said compliance information being communicated to the user at the remote location via the user's cellular device.

6. The method of claim 5 wherein the regulatory data includes material safety data sheet (MSDS) data.

7. The method of claim 5 further comprising:
providing the customer with the option of receiving the compliance information via a voice file in a language different than a local language.

8. The method of claim 7 wherein the voice file is language-translated MSDS data.

9. A system of managing regulatory information associated with environment, health and safety data, comprising:
a database of regulatory data associated with a plurality of chemical products;
a database configured to maintain selected elements of the regulatory data, wherein the selected elements correspond to chemical products identified by the user;
a regulatory server configured to update the regulatory data with regulatory authorities received from a plurality of regulatory authorities;
a server providing the user with compliance information relating to the selected elements in response to the user scanning a QR code on a label associated with a chemical container at a remote location with the user's cellular device, and providing the user with the option of receiving the compliance information via a text file or voice file, with said compliance information being communicated to the user at the remote location via the user's cellular device.

10. The system of claim 9 wherein the regulatory data includes material safety data sheet (MSDS) data.

11. The system of claim 9 further comprising:
providing the user with the option of receiving the compliance information via a voice file in a language different than a local language.

12. The system of claim 11 wherein the voice file is language-translated MSDS data.
